(19) United States
(12) Patent Application Publication
(10) Pub. No.: US 2009/0099905 A1
(43) Pub. Date: Apr. 16, 2009

(54) Method and System for Efficient Cost and Resource Management Using Predictive Techniques

(76) Inventors: Orville McDonald, Seattle, WA (US); Troid Edwards, Atlanta, GA (US)

Correspondence Address: WILSON DANIEL SWAYZE, JR., 3804 CLEARWATER CT., PLANO, TX, 75025, US

(21) Appl. No.: 12/244,249

(22) Filed: Oct. 2, 2008

Related U.S. Application Data
(60) Provisional application No. 60/997,354, filed on Oct. 2, 2007.

(51) Int. Cl. G06Q 10/00

(52) U.S. Cl. 705/10; 705/8

(57) ABSTRACT

A method and system to operate a load may include the steps of determining cost data for a resource of the load, forming a regression analysis based on the cost data and other data, generating usage bands based on the cost data and regression analysis, generating a plurality of tasks to correspond to the usage bands, executing the task to control the resource based upon a current cost and the usage bands. The cost may be obtained from a plurality of sources, and the cost may be obtained from a wholesale cost. The cost may be obtained from a future cost, and the cost may be an independent cost. The method and system may include generating a load weight based on a predetermined period of time, and the task may include throttling the load. The task may include purchasing additional resources, and the usage bands may include a high-cost usage band. The usage bands may include an average cost usage band, and the usage bands may include a low cost usage band.

### PRIORITY

The present invention claims priority based on 35 USC section 119 and based on a provisional application filed on Oct. 2, 2007 with a Ser. No. 60/997,354

### FIELD OF THE INVENTION

The present invention relates to cost allocation and more particularly to a method and apparatus for cost allocation using a multitude of factors.

### BACKGROUND OF THE INVENTION

For a number of years, businesses have been attempting to forecast the cost of various aspects of their business in a systematic manner. Controlling the cost of a business is perhaps the one factor in which businesses spend a great deal of time and energy and in which businesses have not achieved satisfactory results.

### SUMMARY

A method and system to operate a load may include the steps of determining cost data for a resource of the load, forming a regression analysis based on the cost data and other data, generating usage bands based on the cost data and regression analysis, generating a plurality of tasks to correspond to the usage bands, executing the task to control the resource based upon a current cost and the usage bands.

The cost may be obtained from a plurality of sources, and the cost may be obtained from a wholesale cost.

The cost may be obtained from a future cost, and the cost may be an independent cost.

The method and system may include generating a load weight based on a predetermined period of time, and the task may include throttling the load.

The task may include purchasing additional resources, and the usage bands may include a high-cost usage band.

The usage bands may include an average cost usage band, and the usage bands may include a low cost usage band.

### BRIEF DESCRIPTION OF THE DRAWINGS

FIG. 1 illustrates a system of the present invention;

FIG. 2 illustrates a flow chart of the operation of the system of the present invention.

### DETAILED DESCRIPTION

An improved Advanced Resource Management System (ARMS) system may manage both resource consumption and costs of an asset for a business or other organization which may be referred to as a load in a real-time and predictive manner.

One aspect of the Advanced Resource Management System may be to calculate the resources which may be required in order to operate the asset or load, and one aspect may be to calculate the cost of the resource which the load may consume in order to operate by use of an meter in order to make choices in how much resources may be allocated to the load and how much resources should be conserved for future use by the load.

The Advanced Resource Management System may employ regression analyses in order to determine the relevant factors which may affect the availability of a resource, and the regression analysis may be used to predict the scarcity of the resource in the future based on current factors. These factors may help to determine the future price of the resource.

In order to achieve these advantages, the Advanced Resource Management System may use a plurality of usage bands that correspond to tasks which may provide directions or suggestions for the operation of the load. The usage bands may be used to determine the consumption range for the load and may include a high cost usage band, average cost usage band and a low cost usage band which may correspond to low consumption, average consumption or high consumption (which may include storage of resources for use in the future) of the resource for the load. Market conditions for the resource may vary the prices for the resource and the price of the resource may determine the particular usage band that is employed for the allocation of the resource for the load. As prices for resources fluctuate, the usage band is used to determine if the spot-rate for the resource is high or low based on preferred consumption.

Once the price determines whether the high cost usage band, the average cost usage band or the low cost usage band is to be employed, the employed usage band determines a task to determine how the load is to be operated based upon the allocated resource. For example, the high cost usage band may include high cost tasks. The high cost tasks may include a throttling back of the operation of the load. For example, if the load is a factory, throttling back may include reducing the number of hours of operation or the number of assembly lines in operation. If the load is an airplane, throttling back may include operating the airplane for a fewer hours or the number of engines or seats on a flight. Other examples of tasks may include, but are not limited to, buy/sell resources and/or throttle loads.

The task may change the resource allocation to the load which may be determined by historical consumption, regression analyses of the resource, and the placement of the spot-rate of the resource on the usage band or other such actions. Furthermore, additional task from the usage band may be based on another task. For example, if the task is to reduce the use of electricity, this task can result in the additional task of the acquisition of carbon credits which may affect the cost of another resource.

The above features briefly mentioned may be expanded on in the following description.

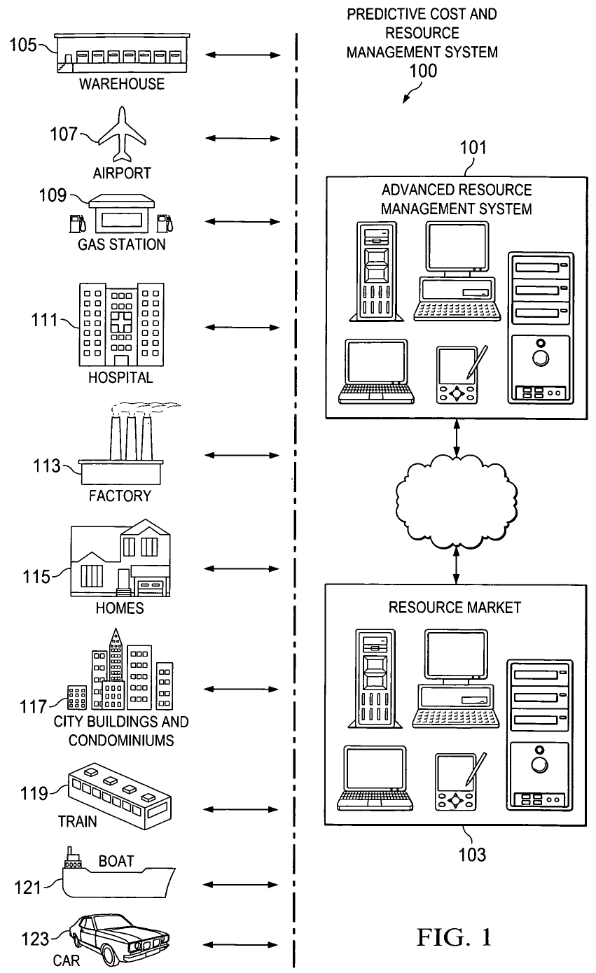

FIG. 1 illustrates an overview of the system 100 of the present invention. FIG. 1 illustrates the Advanced Resource Management System 101 which may include a computer, a personal computer, a laptop computer a PDA, in-home displays, server, Web services or other such device. Furthermore, FIG. 1 illustrates that the Advanced Resource Management System 101 may be connected to the resource market 103 in order to obtain cost information for the loads 105, 107, 109, 111, 113, 115, 117 which may be in communication with the Advanced Resource Management System 101. The load 105, 107, 109, 111, 113, 115, 117 may be collectively, partially or individually referred to as the load. First, a load is registered with the ARMS via for example with a home area network and the load may send data corresponding to the load to the Advanced Resource Management System. FIG. 1 illustrates several examples that could be considered a load. In general, a load is an entity that consumes resources in order to provide a service or good for the consumer. FIG. 1 illustrates that the load could be a factory building 113 or factory buildings, a home 115, city buildings 117, a hospital 111, a gas station 109, and airport 107 or warehouse 105. The load is not necessarily limited to buildings but could be vehicles or other types of goods and services. The load generally requires resources in order to function in an expected manner. These resources may be transformed by the load into goods or services which may be desired by the consumers or users of the load. In general, the resources may be required over time and may be replenished in order that the load may continue to function for the users. The quantity of the resources which may be required by the load may change over time. The load may require more or less of the resource in the future. Furthermore, there may be a cost associated with a load, and this cost may vary over time. The cost may increase over time or the cost may decrease in some instances or may remain the same. The types of resources may vary from load to load, and the quantity of resources used by each individual load may vary. For example, different hospitals may require different supplies because of the different number of patients and the different physical size of the hospitals.

It is desirable to be able to have a method and apparatus which may be able to predict how the different loads will change over time in terms of both quantity and costs. This data may be communicated by any type of two-way communication network or in other ways to transfer information. The ARMS may obtain cost data which may be real-time for the resource for each load from the market where the resource may be traded and/or value is quoted. As the price fluctuates, the ARMS may change the activities of the load and/or may buy/sell resources in the market where the resource is traded.

The load may be registered via HAN/LAN with the Advanced Resource Management System in order to begin the process. A load may be a device that consumes a resource and may produce a good or service for a user or consumer of the load. The Advanced Resource Management System includes a spot-rate retriever in order to determine the cost of the resource or resources which may be consumed by the load. The spot-rate retriever may obtain the spot rate cost for a resource from multiple sources including, but not limited to, wholesale generation rates, independent rates, tariff listings for the resource, futures exchange markets and other such sources. These obtained rates may be used in cooperation with usage bands that may be used to implement tasks to direct the operation of the load.

Another aspect of the analysis by the Advanced Resource Management System may include consumption regression analyses of the resource of the loads. The regression analysis may consider other factors and other sources for data other than the cost data for the resource. In general, the regression analysis may consider factors which may affect the cost for the resource or may affect the operation of the load. The regression analysis may take in data from different sources including, but not limited to, weather, temperature, energy demand, worldwide supply, local supply, processing capacity and other factors that may not be discussed, but could be used in the regression analysis. Regression analyses are performed on the aforementioned data by the Advanced Resource Management System in order to adjust spot-rate data to account for factors that may not be considered by the source of the spot-rate data.

A useful variable may be a load weight which may provide a measure of the consumption of the resource for the load over a predetermined period of time. Other financial weights may be employed including the amount of carbon footprint and other such measures. The consumption of a resource as instantaneously measured may vary. It may be desirable to be able to calculate and compare a measure of resource consumption over a period of time. This may provide a more stable and accurate view of the consumption of the resource by the load. As loads consume resources, a load weight may be calculated and the load weight may be a measure of resource consumption over an average period of time. Load weight calculations may enable the Advanced Resource Management System to more accurately determine how heavy a load is from a consumption perspective. Knowing the long-term financial weight of a load may be an important factor in predicting future costs of running the load as prices fluctuate.

One important function of the Advanced Resource Management System is to control the cost for the resource, and consequently to control the costs for the load. In order to control costs, it may be necessary to throttle the use of resources by the load (which means in a great number of cases that the load operates at a lower level or may be completely shut down for a period of time). Controlling costs for loads may determine the cost of the resource of the load to initiate throttling the load. One method may be to have a threshold or pre-determined cost when exceeded results in the load being throttled. A more sophisticated approach which may be taken by the Advanced Resource Management System may include dynamically reviewing consumption costs for the load, resources available, market data, and other types of data and then acting accordingly. The Advanced Resource Management System receives the spot rate data of the resource and performs the regression analysis. Following this approach, the Advanced Resource Management System may generate a plurality of usage bands which may correspond to different costs for the resource. Once the spot-rate data is retrieved and the regression analyses are performed and the usage bands are generated. The Advanced Resource Management System may employ any number of usage bands; however for description purposes, three usage bands will be discussed. The usage bands may be a high cost usage band which may correspond to a 1) high spot-rate for the period, an average cost usage band which may correspond to a 2) moving spot-rate average, and a low cost usage band which may correspond to a 3) low spot-rate for the period. A regression multiplier may be applied to these spot rate average values to normalize the results for predictions on future costs.

The usage bands may correspond to tasks which may be directions or suggestions for operation of the load and for the application of resources for that particular load. A starting task may be based on spot rates or may be based upon a demand resource which may be obtained from a resource supplier for example a utility. For example the resource supplier may send out a demand response for the load, and the ARMS may respond to the demand response and perform tasks on a non-priority loads. The ARMS may also notify the resource supplier of the status of the requests within a predetermined time. A high-cost task may correspond to the high cost usage band and may include a set of directions for operation of the load when the current cost of the resource falls within the boundaries of the high cost usage band. An average cost task may correspond to the average cost usage band and may include a set of directions or suggestions for operation of a load when the current cost of the resource falls below the lower boundary of the high cost usage band and above the upper boundary of the low cost usage band. A low-cost task may correspond to the low cost usage band and may include a set of directions or suggestions for operation of the load when the current cost of the resource falls below the upper boundary of the low cost usage band.

When a new spot rate is mapped against the high cost usage band, the average cost usage band and the low-cost usage band, tasks are performed on the resources of the load depending on where on the usage band the spot-rate maps to.

High-cost tasks may be performed when the current spot-rate maps below or equal to the high spot-rate for the time period to be examined and above the moving spot-rate average. A highest spot-rate for the time period may become the upper boundary for the high cost usage band because a new high spot-rate resets the upper bound marker. In a similar fashion, a low spot rate for the time. They become the lower boundary for the low-cost usage band. The Advanced Resource Management System may evaluate the level of granularity of ranges in the usage band to determine what usage band task must be performed, which is described in greater detail later. Once the current spot rate is within the upper cost usage band, there may be at least two tasks which may be invoked. First, if the spot cost may be between a predetermined first sub band within the high cost usage band, the operation of the load may continue as if the spot cost were within the average cost usage band, namely the operation of the load may continue as normal. Second, if the spot cost may be between a predetermined second sub band within the high cost usage band, the operation of the load may be curtailed or throttled for the amount of time that the spot cost is within the second sub band. The amount which the load may be throttled may be based upon the load weight, for example, the Advanced Resource Management System may desire to maintain a predetermined load weight. The Advanced Resource Management System may execute a throttling override to override the throttling of the load for example, a throttling override may be appropriate when pre-paid energy which may be less expensive than the spot rate energy had previously been purchased. Furthermore, the supply of energy which may have been prepaid may be compared to the load weight to get an idea of when additional energy will be needed which may need to be purchased at the spot rate.

Lower-cost tasks are those that occur when the current spot-rate maps within or equal to the boundaries of the low-cost usage band. The Advanced Resource Management System may evaluate the level of granularity of ranges in the lower-cost usage band to determine what specific tasks are performed. The Advanced Resource Management System may perform at least two lower costs tasks based upon two sub low-cost usage bands. If current spot rate is between the first lower-cost sub band, the operation of the load may continue in a normal manner. If the current spot rate is between a second lower-cost sub band, the operation of the load may continue in a normal matter and the resource such as energy may be purchased based upon the load weight and the aggressiveness that the relatively cheap resource may be purchased. Additional, the Advanced Resource Management System may purchase resources less aggressively if the trend is indicating that prices will continue to get lower in order that resources could be purchased at even a cheaper cost. Purchased resources may not count against what is currently being used but instead may be stored for later use. More than one task may be associated with a single usage band and the particular function of the task may be expanded beyond those described herein.

A load may include distributed resources which a task may be directed in order to simultaneously allocate the distributed resources. For example, a home may have two sources of energy which may be gas and electricity. The task may use the rate for each of the distributed resources in order to determine which resource should be allocated. For example, if natural gas is cheaper than electricity, then the home may use the natural gas as the resource. If electricity is cheaper than natural gas, then the home may use the electricity as the resource. In order to allocate between the resources, the cost of the different sources, here natural gas and electricity, may be determined. A net meter may be employed in order to determine the net flow of energy both in and out of the home. The net meter may be helpful when the load such as a home may generate resources and may use those resources during peak periods. For example, a home may have a turbine/generator which may generate electricity which may be used by the home.

A resource may come from a load that normally consumes resources. In another example, the load may be a vehicle which may be charged from the electrical supply from the home. If the vehicle is plugged in and charging, the energy use of the home may rapidly increase. Once the vehicle is fully charged, the vehicle may be self-sufficient for a period of time. Alternatively, the electricity stored in a vehicle may be used, not for the vehicle, but may be transferred to the electrical system, generating or returning the resource. Vehicles may be mobile and may require energy at a location other than where the vehicle was charged last. The vehicle may be registered, and consequently when charged at another location; however, the resource may be allocated to the original location. The vehicle may have a battery management system which may be in communication with the Advanced Resource Management System.

As was previously mentioned, usage band and the associated tasks may determine the operation of a load based upon the specific position within a usage band. Usage band tasks may be registered in the Advanced Resource Management System, and the usage band tasks may be invoked based on spot-rate mapping on the usage band.

Furthermore, other factors may be used to account for outside influences (for example, weather, geopolitical risks, etc.) that may be included in the calculation by the regression analyses. The above mentioned tasks may be sufficiently flexible to respond to the needs of loads. Some examples of tasks used by this invention include the execution of DSM programs, purchasing resources, selling resources, using pre-paid resources, throttling loads, flagging loads for investigation, turning loads on, turning loads off, reporting the costs of loads, and remote control of loads as well as other tasks.

When spot-rates are low enough, it is advantageous for a user to purchase energy at lower than average rates. Load consumption history which may be stored in the Advanced Resource Management System may determine how much resources are used in a time period, and then the Advanced Resource Management System may pool the demand from a multitude of loads into one purchase. End users can set their purchase quantity by currency or consumption/depletion.

During peak/high spot-rates non-critical loads may be throttled with the above mentioned tasks. Once the spot-rate may be reduced to a sufficient level or other conditions such as described above, the load may continue to operate in a normal manner. End-users may have the option however, to continue to operate the load with a non-critical load task at peak times. Furthermore, during periods of high resource spot rates, an end user may also use their prepaid resources instead of selling it. This gives end users an opportunity to lower their resource costs. Once all of the prepaid resource is consumed then the end user may resume consuming resources at the market spot rate.

End users may under consume their prepaid resource, and these users may benefit by selling their excess resources. Just as a resource may be purchased in the futures market, prepaid resources may also be bundled and sold automatically by the Advanced Resource Management System. Various methods can be used to determine when a resource may be sold including:

End of cycle check

High resource spot rates

Pre-determined dates (fiscal year-end, tax, etc.)

Excess capacity for duration of time.

On demand sale

Depending on the chosen method, different techniques may be incorporated into the tasks to determine how much energy will be sold.

Out of compliance loads may be flagged for investigation. Erratic resource consumption or deviations from regulatory rules may be a few of the reasons for flagging a load for investigation. Furthermore, loads may be turned on or off remotely by an end-user. This may require an end-user to log into the Advanced Resource Management System and change the configuration.

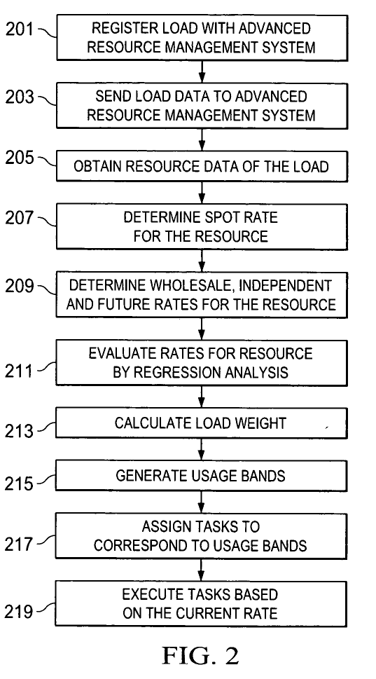

FIG. 2 illustrates the steps in accordance with the operation of the system.
In step 201, the load may be registered with the Advanced Resource Management System, and in step 203, load data may be sent to the Advanced Resource Management System. In step 205, the resource data of the load may be obtained, and in step 207, the spot rate for the resources may be determined. In step 209, the wholesale, independent and future rates for the resource may be determined, and in step 211, the rates for the resource may be evaluated by regression analysis. In step 213, the load weight may be calculated, and in step 215, usage bands may be generated. In step 217, tasks may be assigned to correspond to usage bands, and in step 219, tasks may be executed based upon the current rate of the resource.

1. A method to operate a load, comprising the steps of:
determining cost data for a resource of the load;
forming a regression analysis based on the cost data and other data;
generating usage bands based on the cost data and regression analysis;
generating a plurality of tasks to correspond to the usage bands;
executing the task to control the resource based upon a current cost and the usage bands.

2 A method to operate a load as in claim 1, wherein the cost is obtained from a plurality of sources.

3 A method to operate a load as in claim 1, wherein the cost is obtained from a wholesale cost.

4. A method to operate a load as in claim 1, wherein the cost is obtained from a future cost.

5. A method to operate a load as in claim 1, wherein the cost is an independent cost.

6. A method to operate a load as in claim 1, wherein the method includes the step of generating a load weight based on a predetermined period of time.

7. A method to operate a load as in claim 1, wherein the task includes throttling the load.

8. A method to operate a load as in claim 1, wherein the task includes purchasing additional resources.

9. A method to operate a load as in claim 1, wherein the usage bands include a high-cost usage band.

10. A method to operate a load as in claim 1, wherein the usage bands include an average cost usage band.

11. A method to operate a load as in claim 1, wherein the usage bands include a low cost usage band.

12. A system, comprising;
a load to be operated by the system:
a management infrastructure to be operated in accordance with the following steps:
determining cost data for a resource of the load;
forming a regression analysis based on the cost data and other data;
generating usage bands based on the cost data and regression analysis;
generating a plurality of tasks to correspond to the usage bands;
executing the task to control the resource based upon a current cost and the usage bands.

13. A system as in claim 12, wherein the cost is obtained from a plurality of sources.

14. A system as in claim 12, wherein the cost is obtained from a wholesale cost.

15. A system as in claim 12, wherein the cost is obtained from a future cost.

16. A system as in claim 12, wherein the cost is an independent cost.

17. A system as in claim 12, wherein the method includes the step of generating a load weight based on a predetermined period of time.

18. A system as in claim 12, wherein the task includes throttling the load.

19. A system as in claim 12, wherein the task includes purchasing additional resources.

20. A system as in claim 12, wherein the usage bands include a high-cost usage band.
